(19) United States
(12) Patent Application Publication
(10) Pub. No.: US 2026/0089484 A1
(43) Pub. Date: Mar. 26, 2026

(54) SYSTEM AND METHOD FOR WIRELESS ROAMING

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/339,876

(22) Filed: Sep. 25, 2025

Related U.S. Application Data
(60) Provisional application No. 63/698,901, filed on Sep. 25, 2024.
(60) Provisional application No. 63/766,668, filed on Mar. 4, 2025.
(60) Provisional application No. 63/831,612, filed on Jun. 27, 2025.

(51) Int. Cl. H04W 8/14; H04W 8/24; H04W 88/10

(52) U.S. Cl. CPC H04W 8/14; H04W 8/24; H04W 88/10

(57) ABSTRACT

Embodiments of a method and apparatus for wireless communications are disclosed. In an embodiment, a wireless device includes a controller configured to generate Seamless Mobility Domain (SMD) capabilities information of an SMD and a transceiver configured to transmit the SMD capabilities information to a second wireless device for wireless roaming within the SMD.

### CROSS-REFERENCE TO RELATED APPLICATIONS

This application is entitled to the benefit of U.S. Provisional Patent Application Ser. No. 63/698,901, filed on Sep. 25, 2024, U.S. Provisional Patent Application Ser. No. 63/766,668, filed on Mar. 4, 2025, and U.S. Provisional Patent Application Ser. No. 63/831,612, filed on Jun. 27, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. A wireless device roams within a wireless communications system in an operation, such as, a seamless roaming operation.

### SUMMARY

Embodiments of a method and apparatus for wireless communications are disclosed. In an embodiment, a wireless device includes a controller configured to generate Seamless Mobility Domain (SMD) capabilities information of an SMD and a transceiver configured to transmit the SMD capabilities information to a second wireless device for wireless roaming within the SMD. Other embodiments are also disclosed.

In an embodiment, the wireless device includes an access point (AP) MLD with at least one affiliated wireless AP, and the second wireless device includes a non-AP MLD with at least one affiliated non-AP station (STA).

In an embodiment, the transceiver is further configured to transmit the SMD capabilities information to the non-AP MLD for the wireless roaming from a current serving AP multi-link device (MLD) to a target AP MLD within the SMD.

In an embodiment, the SMD capabilities information includes an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming.

In an embodiment, the information regarding the authentication and PTK generation supported by all the AP MLDs in the SMD is carried in a Robust Security Network Extension Element (RSNXE) element.

In an embodiment, the information regarding the authentication and PTK generation supported by all the AP MLDs in the SMD is carried in a Robust Security Network Element (RSNE) element.

In an embodiment, the controller is further configured to generate a Reduced Neighbor Report (RNR) that contains information of a candidate target AP MLD, which carries a mobile domain identifier (MDID) of the SMD that the candidate target AP MLD belongs to.

In an embodiment, the mobile domain identifier (MDID) of the SMD that the candidate target AP MLD belongs to includes a non-transmitted Basic Service Set Identifier (BSSID) index of an AP whose affiliated AP MLD is in same SMD as the candidate target AP MLD.

In an embodiment, the controller configured to generate a link reconfiguration request or response to terminate a downlink (DL) frame exchange with the second wireless device.

In an embodiment, the link reconfiguration request or response includes a reconfiguration multi-link element without a link information field.

In an embodiment, a Basic Service Set (BSS) Transition Management (BTM) Query carries an indication of soliciting candidate target AP MLDs through a BSS Transition Query Reason field.

In an embodiment, the wireless device includes a wireless multi-link device (MLD), the second wireless device includes a second wireless MLD, and the transceiver includes a wireless transceiver configured to transmit the SMD capabilities information to the second wireless MLD through a wireless link between the wireless MLD and the second wireless MLD.

In an embodiment, a method for wireless communications includes at a first wireless device, generating Seamless Mobility Domain (SMD) capabilities information of an SMD; and from the first wireless device, transmitting the SMD capabilities information to a second wireless device for wireless roaming within the SMD.

In an embodiment, the wireless device includes an access point (AP) MLD with at least one affiliated wireless AP, and the second wireless device includes a non-AP MLD with at least one affiliated non-AP station (STA).

In an embodiment, transmitting the SMD capabilities information to the second wireless device for wireless roaming within the SMD includes transmitting the SMD capabilities information to the non-AP MLD for the wireless roaming from a current serving AP multi-link device (MLD) to a target AP MLD within the SMD.

In an embodiment, the SMD capabilities information includes an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming.

In an embodiment, the information regarding the authentication and PTK generation supported by all the AP MLDs in the SMD is carried in a Robust Security Network Extension Element (RSNXE) element.

In an embodiment, information regarding the authentication and PTK generation supported by all the AP MLDs in the SMD is carried in a Robust Security Network Element (RSNE) element.

In an embodiment, the method further includes at the first wireless device, generating a Reduced Neighbor Report (RNR) that contains information of a candidate target AP MLD, which carries a mobile domain identifier (MDID) of the SMD that the candidate target AP MLD belongs to.

In an embodiment, the mobile domain identifier (MDID) of the SMD that the candidate target AP MLD belongs to includes a non-transmitted Basic Service Set Identifier (BSSID) index of an AP whose affiliated AP MLD is in same SMD as the candidate target AP MLD.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 illustrates a seamless roaming operation of a non-AP (STA) MLD in accordance with an embodiment of the invention.

FIG. 5 illustrates a frame format in accordance with an embodiment of the invention.

FIG. 6 illustrates a Reduced Neighbor Report (RNR) element format in accordance with an embodiment of the invention.

FIG. 7 illustrates a neighbor AP information field format in accordance with an embodiment of the invention.

FIG. 8 illustrates a Target Beacon Transmission Time (TBTT) information header subfield format in accordance with an embodiment of the invention.

FIG. 9 illustrates a TBTT information field format in accordance with an embodiment of the invention.

FIG. 10 illustrates a Basic Service Set (BSS) parameters subfield format in accordance with an embodiment of the invention.

FIG. 11 illustrates an MLD parameters subfield format in accordance with an embodiment of the invention.

FIG. 12 illustrates a BSS Transition Management (BTM) query frame action field format in accordance with an embodiment of the invention.

FIG. 13 illustrates a BTM query frame action field format in accordance with an embodiment of the invention.

FIG. 14 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

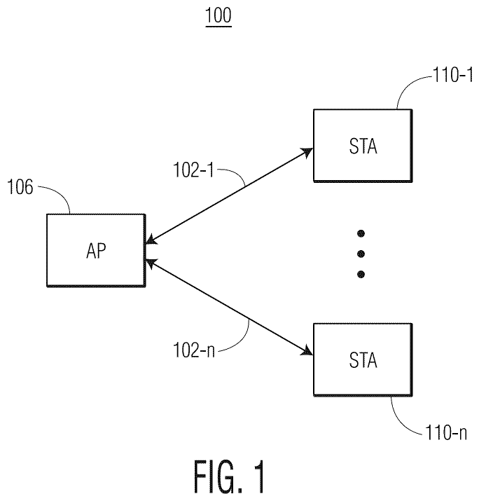

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy”communication protocols.

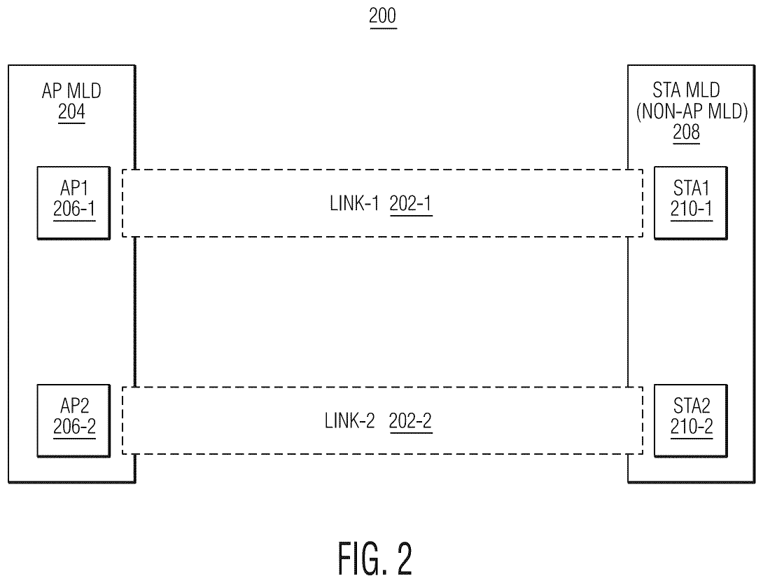

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities common to all APs affiliated with the AP MLD 204 (e.g., association establishment, reordering of frames, etc.) and a link specific part of the AP MLD 204, i.e., the APs 206-1 and 206-2, implement upper layer MAC specific to a link and lower layer MAC functionalities (e.g., beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

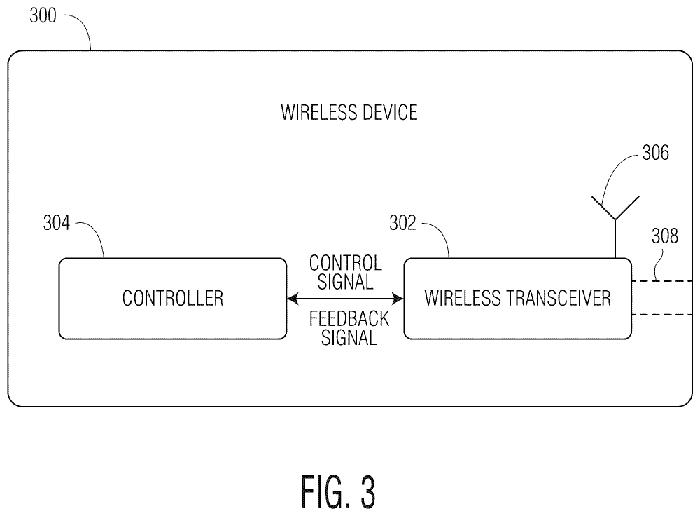

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless roaming technology that efficiently and securely conveys wireless roaming information, for example, information related to data, communications links, and/or wireless devices (e.g., operation and/or capability parameters of wireless devices) within the wireless communications system.

In accordance with one or more embodiments, the controller 304 is configured to generate Seamless Mobility Domain (SMD) capabilities information of an SMD, and the wireless transceiver 302 is configured to transmit the SMD capabilities information to a second wireless device for wireless roaming within the SMD, for example, wirelessly transmit the SMD capabilities information to the second wireless device through the at least one antenna 306. In some embodiments, an SMD includes multiple wireless devices with which the second wireless device can establish wireless links and conduct frame exchanges. In some embodiments, an SMD includes a current serving AP multi-link device (MLD) that currently maintains wireless links with the second wireless device and a target AP MLD with which the second wireless device establishes wireless links and conducts frame exchanges during the wireless roaming. In some embodiments, the wireless device 300 includes a reporting AP within the SMD. In some embodiments, the wireless device 300 is a current serving AP MLD within the SMD or a target AP MLD within the SMD. In some embodiments, the wireless device includes an access point (AP) MLD with at least one affiliated wireless AP, and the second wireless device includes a non-AP MLD with at least one affiliated non-AP station (STA). In some embodiments, the wireless transceiver 302 is further configured to transmit the SMD capabilities information to the non-AP MLD for the wireless roaming from a current serving AP MLD to a target AP MLD within the SMD. In some embodiments, the SMD capabilities information includes an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming. In some embodiments, the information regarding the authentication and PTK generation supported by all the AP MLDs in the SMD is carried in a Robust Security Network Extension Element (RSNXE) element. In some embodiments, the information regarding the authentication and PTK generation supported by all the AP MLDs in the SMD is carried in a Robust Security Network Element (RSNE) element. In some embodiments, the SMD capabilities information includes information regarding a sequential way and a parallel way for the wireless roaming within the SMD. In some embodiments, based on the SMD capabilities information, the second wireless device selects the sequential way or the parallel way for the wireless roaming within the SMD. In some embodiments, the controller 304 is further configured to generate a Reduced Neighbor Report (RNR) that contains information of a candidate target AP MLD, which carries a mobile domain identifier (MDID) that identifies the SMD the candidate target AP MLD belongs to. In some embodiments, the mobile domain identifier (MDID) of the SMD that the candidate target AP MLD belongs to includes a non-transmitted Basic Service Set Identifier (BSSID) index of an AP whose affiliated AP MLD is in the same SMD as the candidate target AP MLD. In some embodiments, the MDID announced in a link to identify the candidate target AP MLD is the identifier that is meaningful in the link. As one example, a candidate target AP MLD reported in link1 and link2 of the serving AP MLD can be announced with MDID 3 in link1 and MDID1 in link2. In some embodiments, the controller 304 is further configured to generate a link reconfiguration request or response to terminate a downlink (DL) frame exchange with the second wireless device. In some embodiments, the link reconfiguration request or response includes a reconfiguration multi-link element without a link information field. In some embodiments, the wireless device 300 is compatible with an Institute of Electrical and Electronics Engineers (IEEE) 802.11 protocol. In some embodiments, a Basic Service Set (BSS) Transition Management (BTM) Query carries an indication of soliciting candidate target AP MLDs through a BSS Transition Query Reason field. In some embodiments, the wireless device 300 includes a wireless multi-link device (MLD), the second wireless device includes a second wireless MLD, and the wireless transceiver 302 is configured to transmit the SMD capabilities information to the second wireless MLD through a wireless link between the wireless MLD and the second wireless MLD.

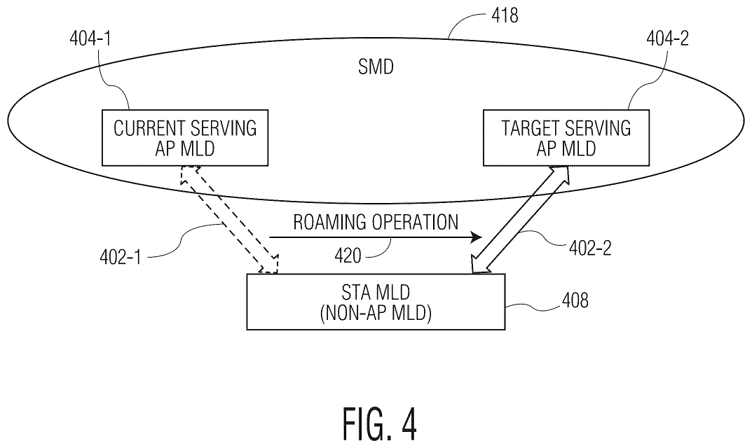

FIG. 4 illustrates a seamless roaming operation 420 of a non-AP (STA) MLD 408 in accordance with an embodiment of the invention. In the seamless roaming operation 420 illustrated in FIG. 4, the non-AP (STA) MLD 408 roams from a current serving AP MLD 404-1 of an SMD 418 to a target AP MLD 404-2 of the SMD 418. Specifically, before the seamless roaming operation 420, the non-AP (STA) MLD 408 has the established links 402-1 with the current serving AP MLD 404-1 and conducts the frame exchanges with the current serving AP MLD 404-1. In the seamless roaming operation 420, the non-AP (STA) MLD 408 establishes the links 402-2 with the target serving AP MLD 404-2. Within a temporary duration after the seamless roaming, the non-AP MLD may receive the downlink (DL) data frames from both the current serving AP MLD 404-1 and the target AP MLD 404-2 while transmitting the uplink (UL) data frames to the target AP MLD 404-2 only. In some embodiments, after the temporary duration, the STA MLD 408 stops the frame exchanges with the current serving AP MLD 404-1, and executes the frame exchanges with the target serving AP MLD 404-2.

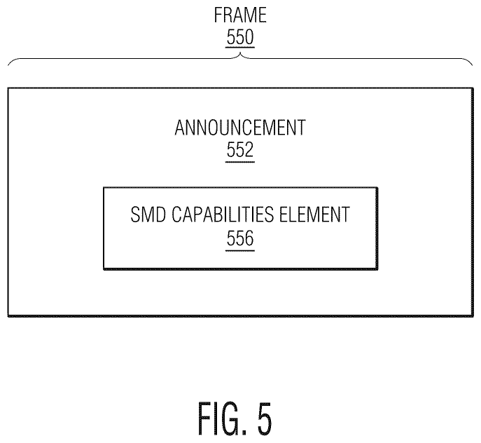

FIG. 5 illustrates a frame format 550 in accordance with an embodiment of the invention. The frame format 550 illustrated in FIG. 5 can be used for communications by the wireless communications system 100 depicted in FIG. 1, by a STA/AP affiliated with the multi-link (ML) communications system 200 depicted in FIG. 2, and/or the wireless device 300 depicted in FIG. 3. In the embodiment depicted in FIG. 5, the frame format 550 includes an announcement 552 that may include an SMD capabilities element 556. In some embodiments, the SMD capabilities element 556 includes SMD capabilities information.

In some implementations, in a roaming procedure, an (optional) Step 1 involves candidate target serving AP MLD recommendation. For example, a non-AP MLD acquires the candidate target serving AP MLDs through its current serving AP MLD. Step 2 involves establishing the links with the target serving AP MLD. Step 3 involves roaming from the current serving AP MLD to the target AP MLD (e.g., Distribution System (DS) mapping update with access server, router, or ethernet switch, frame exchange context transfer to the target AP MLD, and/or the UL frame changes for UL Data frames are suspended during step 3). Step 4 involves stopping the UL frame exchanges of Data frames with the current serving AP MLD, and executing the DL frame exchanges of Data frames with the current serving AP MLD and the target AP MLD while executing the UL frame exchanges with the target AP MLD only. Step 5 includes stopping the frame exchanges of Data frames and executing the frame exchanges of Data frames with the target AP MLD. In some implementations, the simultaneous data frame exchanges with two AP MLDs will not happen. It is possible that both the current serving AP MLD and the target AP MLD transmits the DL Data frames for some times after step 4. The UL Data frames can only be transmitted to the target AP MLD.

Some implementations of seamless roaming capabilities, for example, by the wireless communications system 100 depicted in FIG. 1, the multi-link (ML) communications system 200 depicted in FIG. 2, and/or the wireless device 300 depicted in FIG. 3 are described.

In some embodiments, a Seamless Mobility Domain (SMD) Capabilities element is carried in a Beacon and announces the SMD information of the SMD that the reporting AP MLD without multiple BSSID support belongs to and additionally the SMD information of the SMDs that the transmitted BSSID AP's AP MLD with multiple BSSID support belong to, which can include, for example, a SMD MAC address, Temporal Key (TK) renegotiation information regarding whether the SMD requires the TK renegotiation during the roaming, information regarding whether the current serving AP MLD supports the forward of the frames to the target AP MLD, information regarding whether the target AP MLD supports the seamless roaming directly, information regarding Robust Security Network Element (RSNE) and Robust Security Network Extension Element (RSNXE) supported by all the AP MLDs in an SMD.

Some implementations of a neighbor report, for example, by the wireless communications system 100 depicted in FIG. 1, the multi-link (ML) communications system 200 depicted in FIG. 2, and/or the wireless device 300 depicted in FIG. 3 are described.

In some embodiments, a neighbor report includes information regarding whether a reported AP MLD with which a reported AP is affiliated is in a SMD (i.e., a seamless roaming domain) and the SMD address with which the reported AP MLD belongs to (e.g., is affiliated with). In some embodiments, the Multi-Link subelement with a bit can be used to indicate whether the reported AP MLD belong to a SMD. In some embodiments, a new subelement with SMD MAC address, e.g., a SMD Capabilities element, indicates the SMD that the reported AP MLD is in, which may not be needed when only a candidate target AP MLDs in the same roaming domain as the serving AP MLD are reported.

In some embodiments, a neighbor report includes information indicating a resource supported by a candidate target AP MLD (Stream Classification Service (SCS) agreement support, Block Acknowledgement (BA) agreement support, Target Wake Time (TWT) agreement support). Such indication can be a subelement. In some embodiments, SCS agreement support information indicates whether the candidate target AP MLD satisfies the SCS agreement of the non-AP MLD. In some embodiments, the related resource is not reserved. In some embodiments, BA agreement support information indicates whether the candidate target AP MLD satisfies the downlink (DL)/uplink (UL) BA agreements with the non-AP MLD. In some embodiments, the related resource is not reserved. In some embodiments, TWT agreement support information indicates whether the candidate target AP MLD satisfies the TWT agreements of the non-AP MLD. In some embodiments, the related resource is not reserved.

In some embodiments, the neighbor report can be used under Multiple BSSID support or under no multiple BSSID support.

Some implementations of a Reduced Neighbor Report (RNR), for example, by the wireless communications system 100 depicted in FIG. 1, the multi-link (ML) communications system 200 depicted in FIG. 2, and/or the wireless device 300 depicted in FIG. 3 are described.

In some embodiments, a Reduced Neighbor Report (RNR) reuses the current TBTT Information Type (Type 0) and reuses the TBTT length of 16 octets.

In some embodiments, a reserved bit (e.g., B3 in TBTT Information Header field, B7 in BSS Parameters field, or B23 in MLD Parameters field) being named as a Candidate AP MLD Indication field is repurposed to indicate that the TBTT Information field is related to the candidate target AP MLD. In some embodiments, if a TBTT Information field of an AP (AP3) with a Candidate AP MLD Indication field in an RNR element of a Beacon transmitted by a transmitted BSSID AP (AP1) is equal to 1, the AP MLD ID field of the TBTT Information field carries the identifier of the SMD that AP3's affiliated target AP MLD belongs to, and the value in the AP MLD ID field is the same as the BSSID index of the non-transmitted BSSID AP (AP2) whose affiliated AP MLD is in the same SMD as the AP3's affiliated AP MLD. In some embodiments, the AP MLD ID is the identifier of the candidate target AP MLD with which the reported AP is affiliated and its value indicates whether it is a candidate target AP MLD or an AP MLD in the same device with the AP transmitting the RNR element. Under such implements, the non-transmitted BSSID index in a link is used as the SMD ID in the link.

In some embodiments, the BSS Parameter Change Count field is repurposed for the new usage, e.g., AP MLD load, or AP MLD per link load.

In some embodiments, in a first option of SMD identifier, the service set identifier (SSID) is repurposed as the mobile domain identifier (MDID).

In some embodiments, in a second option of SMD identifier, a short SSID is used to indicate the related SMD under multiple BSSID support, i.e., when the candidate target AP MLD's short SSID is the same as the short SSID of an AP of a multiple BSSID AP set, the AP's SMD is the candidate target AP MLD's SMD. In some embodiments, each AP affiliated with an AP MLD announces the candidate target AP MLDs in the same SMD as the AP MLD.

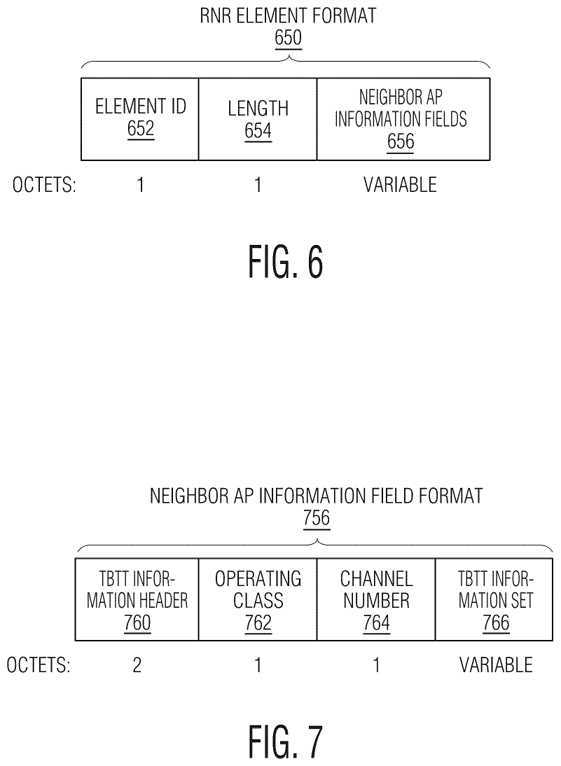

FIG. 6 illustrates a Reduced Neighbor Report (RNR) element format 650 in accordance with an embodiment of the invention. The RNR element format 650 illustrated in FIG. 6 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 6, the RNR element format 650 includes an element identification (ID) field 652 (e.g., one-octet) that may contain element ID information, a length field 654 (e.g., one-octet) that may contain length information, and neighbor AP information fields 656 (e.g., variable length) that may contain neighbor AP information.

FIG. 7 illustrates a neighbor AP information field format 756 in accordance with an embodiment of the invention. The neighbor AP information field format 756 illustrated in FIG. 7 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the neighbor AP information field format 756 includes a Target Beacon Transmission Time (TBTT) information header subfield 760 (e.g., two-octet) that may contain TBTT information header information, an operating class subfield 762 (e.g., one-octet) that may contain operating class information, a channel number subfield 764 (e.g., one-octet) that may contain channel number information, and a TBTT information set subfield 766 (e.g., variable length) that may contain TBTT information.

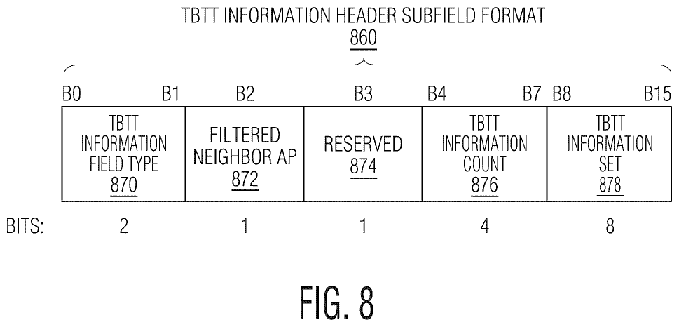

FIG. 8 illustrates a TBTT information header subfield format 860 in accordance with an embodiment of the invention. The TBTT information header subfield format 860 illustrated in FIG. 8 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 8, the TBTT information header subfield format 860 includes a TBTT information field type subfield 870 (e.g., two-bit) that may contain TBTT information field type information, a filtered neighbor AP subfield 872 (e.g., one-bit) that may contain filtered neighbor AP information, a reserved subfield 874 (e.g., one-bit) that may contain reserved information, a TBTT information count subfield 876 (e.g., four-bit) that may contain TBTT information count information, and a TBTT information length subfield 878 (e.g., eight-bit) that may contain TBTT information length information.

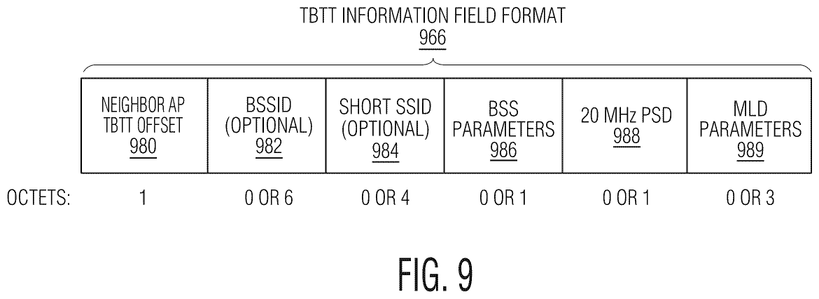

FIG. 9 illustrates a TBTT information field format 966 in accordance with an embodiment of the invention. The TBTT information field format 966 illustrated in FIG. 9 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 9, TBTT information field format 966 includes a neighbor AP TBTT offset subfield 980 (e.g., one-octet) that may contain neighbor AP TBTT offset information, an optional BSSID subfield 982 (e.g., zero or six octets) that may contain BSSID information, an optional short SSID subfield 984 (e.g., zero or four octets) that may contain short SSID information, a BSS parameters subfield 986 (e.g., zero or one octet) that may contain BSS parameter information, a 20 MHz Power Spectral Density (PSD) subfield 988 (e.g., zero or one octet) that may contain 20 MHz PSD information, and an MLD parameters subfield 989 (e.g., zero or three octet) that may contain MLD parameter information.

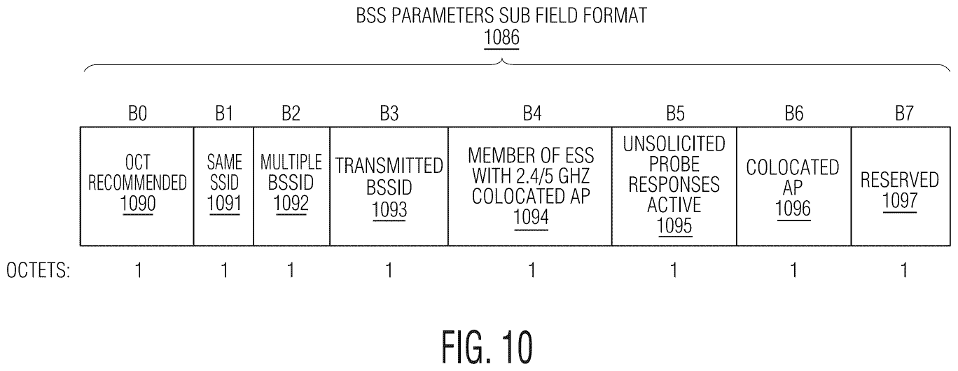

FIG. 10 illustrates a BSS parameters subfield format 1086 in accordance with an embodiment of the invention. The BSS parameters subfield format 1086 illustrated in FIG. 10 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 10, the BSS parameters subfield format 1086 includes an on-channel tunneling (OCT) recommended subfield 1090 (e.g., one-bit) that may contain information indicating whether or not the on-channel tunneling is recommended, a same SSID subfield 1091 (e.g., one-bit) that may contain information indicating whether or not the AP identified by the BSS parameters have the same SSID as the AP that transmits the RNR element carrying the BSS Parameters subfield, a multiple BSSID subfield 1092 (e.g., one-bit) that may contain information indicating whether or not the AP identified by BSS parameters belongs to a multiple BSSID set, a transmitted BSSID subfield 1093 (e.g., one-bit) that may contain information indicating whether or not the AP identified by the BSS parameters have a transmitted BSSID as its BSSID, a member of an Extended Service Set (ESS) with 2.4 GHz/5 GHz Colocated AP subfield 1094 (e.g., one-bit) that may contain information indicating whether the AP identified by the BSS parameters (the reported AP) is part of an ESS where all the APs in the ESS are operating in the same band as the reported AP, and have a corresponding AP operating in 2.4 GHz/5 GHz AP, a unsolicited Probe response active subfield 1095 (e.g., one-bit) that may contain the indication where the reported AP is part of an ESS where all the APs in the same channel as the reported AP transmit unsolicited Probe Response frames every 20TUs (TU representing time unit, a unit of time equal to 1024 microseconds) or less, a colocated AP subfield 1096 (e.g., one-bit) that may contain the information to indicate whether the reported AP is in the same colocated AP set as the transmitting AP, and a reserved subfield 1097 (e.g., one-bit) that may contain reserved information.

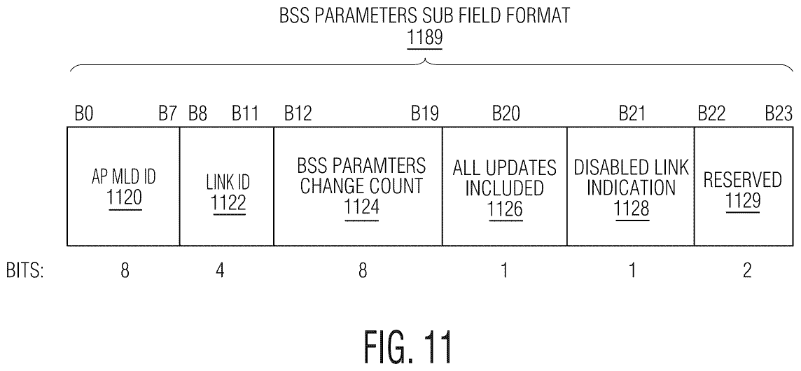

FIG. 11 illustrates an MLD parameters subfield format 1189 in accordance with an embodiment of the invention. The MLD parameters subfield format 1189 illustrated in FIG. 11 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 11, the MLD parameters subfield format 1189 includes an AP MLD ID subfield 1120 (e.g., eight-bit) that may contain AP MLD ID information, a link ID subfield 1122 (e.g., four-bit) that may contain link ID information, a BSS parameters change count subfield 1124 (e.g., eight-bit) that may contain BSS parameters change count information, an all updates included subfield 1126 (e.g., one-bit) that may contain information indicating whether or not the MLD parameters have all updates included, a disabled link indication subfield 1128 (e.g., one-bit) that may contain disabled link indication information, and a reserved subfield 1129 (e.g., two-bit) that may contain reserved information. In some embodiment, if a TBTT Information field with the MLD Parameters subfield contains the information of a reported AP (AP3) that is affiliated with a candidate target AP MLD belonging to the same SMD as a non-transmitted BSSID AP's (AP2) affiliated AP MLD, the AP MLD ID field 1120 of the TBTT Information field carries AP2's non-transmitted BSSID index. In some embodiment, if a TBTT Information field with the MLD Parameters subfield contains the information of a reported AP (AP3) that is affiliated with a candidate target AP MLD belonging to the same SMD as a non-transmitted BSSID AP's (AP2) affiliated AP MLD, the BSS parameters change count subfield 1124 of the TBTT Information field is repurposed to carry AP2's non-transmitted BSSID index.

Some implementations of soliciting information of candidate target AP MLDs, for example, by the wireless communications system 100 depicted in FIG. 1, the multi-link (ML) communications system 200 depicted in FIG. 2, and/or the wireless device 300 depicted in FIG. 3 are described.

In some embodiments, in a first option, a probing procedure is implemented. In some embodiments, the RNR in a Probe Response frame carries the basic information of a candidate target AP MLD.

In some embodiments, a Probe Request frame with a wildcard SSID or wildcard BSSID in address 3 is used to solicit the candidate target AP MLDs of all reporting AP MLDs. In some embodiments, a reporting AP MLD is an AP MLD with which a reporting AP is affiliated. In some embodiments, in one variant, this is disallowed.

In some embodiments, the Probe Request frame with the SSID of a specific reporting AP or the BSSID of a specific reporting AP in address 3 is used to solicit the candidate target AP MLDs of the reporting AP MLD with which the specific reporting AP is affiliated. In some embodiments, in one variant, only the SSID of the current serving AP MLD and only the BSSID of an AP affiliated with the current serving AP MLD are allowed.

In some embodiments, the Probe Response frame carries the information of the requested candidate target AP MLDs in an RNR element.

In some embodiments, the ML Probe procedure is used to acquire the full information of the candidate target AP MLD. In some embodiments, an ML Probe Request frame carries information that indicates whether it is used to solicit information of the candidate target AP MLDs. In some embodiments, the Probe Multi-Link element indicates that the ML Probe is used for candidate target AP MLD probing. Under such embodiments, the indication is carried in the Presence Bitmap field of the Probe Multi-Link element, e.g., by repurposing a reserved bit as the indication. In some embodiments, a new robust Action frame, e.g., a Candidate Target AP MLD Request frame carrying an ML Probe Request, is used, instead of an ML Probe Request, to solicit the information of the candidate target AP MLD(s).

In some embodiments, the ML Probe Request may indicate whether the non-AP MLD requests the report of the candidate target AP MLD's satisfaction of non-AP MLD's resource provided by the current serving AP MLD. In some embodiments, the ML Probe Request may carry the resource request if the required resource request (e.g., SCS request, TWT agreement request, BA agreement request, etc.) is different from the allocated resource by the current serving AP MLD. In some embodiments, the ML Probe Response frame carries the information of the requested candidate target AP MLDs that satisfy the resource request in the ML Probe Request. In some embodiments, the elements in the ML Probe Response carries the information of the candidate target AP MLD's reporting link. In some embodiments, the reporting AP's BSSID of the candidate target AP MLD is carried in a Common Info field of the Basic Multi-Link element. In some embodiments, the reporting AP's BSSID of the candidate target AP MLD is carried at the end of Basic Multi-Link element, and the Common Info field indicates the location of the reporting AP's BSSID of the candidate target AP MLD in the Basic Multi-Link element. In some embodiments, the ML Probe Response frame is carried in a UHR PPDU. In some embodiments, when the AP in the reporting link that is affiliated with the candidate target AP MLD is a non-transmitted BSSID AP (AP3), the ML Probe Response is organized similar to or the same as the Association Response frame where 1) the elements in the frame are AP3's information, and 2) the Per STA Profile(s) in a Basic Multi-Link element of the frame is/are the information of the APs affiliated with the same AP MLD as AP3. In some embodiments, a new type of a robust Action frame, e.g., a Candidate Target AP MLD Response frame with a Basic Multi-Link element, replaces the ML Probe Response frame.

In some embodiments, in a second option, a BSS Transition Management (BTM) is implemented to report the candidate target AP MLD information. In some embodiments, the BSS Transition Management (BTM) Query carries the indication of soliciting candidate target AP MLDs through the BSS Transition Query Reason field. In some embodiments, a new reason value is defined for such purpose. In some embodiments, the AP MLD with which the addressed AP is affiliated and the solicited candidate target AP MLDs are in the same SMD. In some embodiments, in another variant, a reason code is defined for the purpose of the AP MLD with which the addressed AP is affiliated, and the solicited candidate target AP MLDs are in the same SMD.

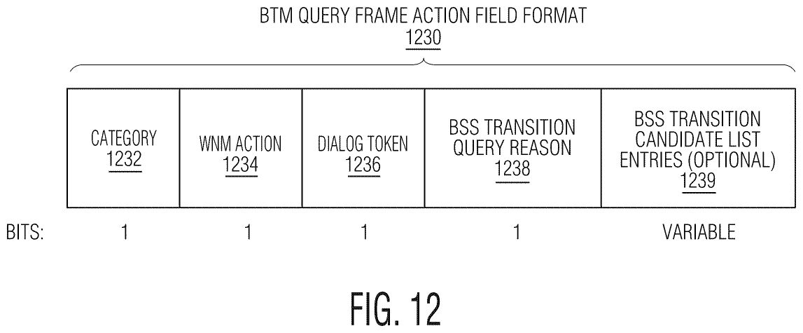

FIG. 12 illustrates a BTM query frame action field format 1230 in accordance with an embodiment of the invention. The BTM query frame action field format 1230 illustrated in FIG. 12 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 12, the BTM query frame action field format 1230 includes a category subfield 1232 (e.g., one-octet) that may contain category information, a Wireless Network Management (WNM) action subfield 1234 (e.g., one-octet) that may contain WNM action information, a dialog token subfield 1236 (e.g., one-octet) that may contain dialog token information, a BSS transition query reason subfield 1238 (e.g., one-octet) that may contain BSS transition query reason information, and an optional BSS transition candidate List Entries subfield 1239 (e.g., variable length) that may contain BSS transition candidate List Entries information.

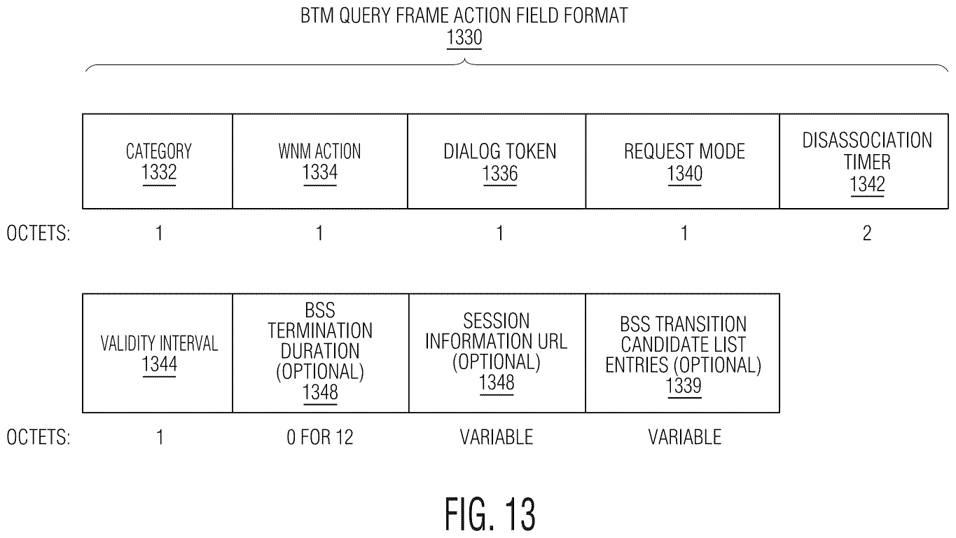

FIG. 13 illustrates a BTM query frame action field format 1330 in accordance with an embodiment of the invention. The BTM query frame action field format 1330 illustrated in FIG. 13 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 13, the BTM query frame action field format 1330 includes a category subfield 1332 (e.g., one-octet) that may contain category information, a WNM action subfield 1334 (e.g., one-octet) that may contain WNM action information, a dialog token subfield 1336 (e.g., one-octet) that may contain dialog token information, a request mode subfield 1340 (e.g., two-octet) that may contain request mode information, a disassociation timer subfield 1342 (e.g., one-octet) that may contain disassociation timer information, a validity interval subfield 1344 (e.g., one-octet) that may contain validity interval information, an optional BSS termination duration subfield 1346 (e.g., zero or 12 octets) that may contain BSS termination duration information, an optional session information Uniform Resource Locator (URL) subfield 1348 (e.g., variable length) that may contain session information URL information, and an optional BSS transition candidate List Entries subfield 1339 (e.g., variable length) that may contain BSS transition candidate List Entries information.

In some embodiments, in a third option, a neighbor report procedure is implemented. In some embodiments, neighbor report request/response are used to acquire the information of the candidate target AP MLD. In some embodiments, the neighbor report element is used to carry the information of the candidate target AP MLD.

In some embodiments, in a fourth option, new action frames are defined. In some embodiments, the new action frames (e.g., a Candidate Target AP MLD (CTAM) Request, a Candidate Target AP MLD Response) are defined. In some embodiments, the CTAM Request frame is used to solicit the candidate target AP MLDs. In some embodiments, the CTAM Response carries an RNR that includes the information of the requested candidate target AP MLDs. In some embodiments, the neighbor report element is used to carry the information of the candidate target AP MLD(s).

Some implementations of roaming preparation and roaming execution, for example, by the wireless communications system 100 depicted in FIG. 1, the multi-link (ML) communications system 200 depicted in FIG. 2, and/or the wireless device 300 depicted in FIG. 3 are described.

In some embodiments, in Option 1, a non-AP MLD is not allowed to initiate the seamless roaming procedure with a target AP MLD while conducting the seamless roaming with another target AP MLD.

In some embodiments, in Option 2, a non-AP MLD is allowed to establish the link(s) with multiple target AP MLDs. However, the non-AP MLD is not allowed to establish the frame exchange context and Distribution System (DS) mapping of the non-AP MLD to multiple target AP MLDs during a seamless roaming procedure.

In some embodiments, if/when the seamless roaming failed (e.g., no response of roaming preparing stage or roaming executing stage being received) or rejected by the target AP MLD, the current serving AP MLD is still the serving AP MLD.

Some implementations of downlink (DL) frame exchanges under seamless roaming, for example, by the wireless communications system 100 depicted in FIG. 1, the multi-link (ML) communications system 200 depicted in FIG. 2, and/or the wireless device 300 depicted in FIG. 3 are described.

In some embodiments, in Option 1, during a roaming executing stage, a Roaming Request/Response or Link Reconfiguration Request/Response are used for frame exchange context and Distribution System (DS) mapping change, additionally for defining/proposing the ending time for DL frame transmission by the serving AP MLD within which the serving AP MLD can transmit DL frames to the non-AP MLD after the seamless roaming is done. In some embodiments, the ending time is proposed by the non-AP MLD and accepted by the serving AP MLD. In some embodiments, before the negotiated time, the AP MLD can early terminate the DL frame exchanges by using a specific frame, e.g., a notification frame or a Link Reconfiguration Response, where the AP MLD is allowed to delete all the links of the non-AP MLD with the serving AP MLD. In some embodiments, before the negotiated time, the non-AP MLD can early terminate the DL frame exchanges by using a specific frame, e.g., a notification frame or a Link Reconfiguration Request, for deleting all the links of the non-AP MLD with the current serving AP MLD. In some embodiments, the DL frames from some downlink (DL) Traffic Identifiers (TIDs) or all DL TIDs can be transmitted by the serving AP MLD before the ending time for DL frame transmission by the serving AP MLD. In some embodiments, the non-AP MLD announces the TIDs whose DL frames can be transmitted by the serving AP MLD before the ending time for DL frame transmission by the serving AP MLD.

In some embodiments, in Option 2, the settings proposed in option 1 are supported by option 2. Additionally, in some embodiments, additionally, the More Data field in DL uncast Data frames transmitted by the serving AP MLD indicate whether it is the last frame transmitted by the serving AP MLD.

Some implementations of peer AP MLD identifier, for example, by the wireless communications system 100 depicted in FIG. 1, the multi-link (ML) communications system 200 depicted in FIG. 2, and/or the wireless device 300 depicted in FIG. 3 are described.

In some embodiments, a management frame for seamless roaming can be addressed to a target AP MLD through a serving AP MLD. In some embodiments, the target AP MLD's MAC address is carried as the peer AP MLD MAC address. In some embodiments, a management frame for seamless roaming can be addressed to the target AP MLD directly. In some embodiments, for such frame, the target AP MLD needs to acquire the non-AP MLD's information by asking the serving AP MLD such that the management frame for seamless roaming will carry the peer AP MLD MAC address. In some embodiments, in Option 1, the current element, e.g., a Reconfiguration Multi-Link element or Probe Multi-Link element, carries the peer AP MLD MAC address. In some embodiments, in Option 2, a new element is defined to carry the peer AP MLD MAC address.

Some implementations of roaming preparation and roaming execution, for example, by the wireless communications system 100 depicted in FIG. 1, the multi-link (ML) communications system 200 depicted in FIG. 2, and/or the wireless device 300 depicted in FIG. 3 are described.

In some embodiments, in Option 1, Link Reconfiguration Request and Link Reconfiguration Response are used in both roaming preparation and roaming execution stage. In some embodiments, the added link(s) at the target AP MLD is/are in power save mode (PSM) unless the frame for adding link(s) at target AP MLD is transmitted directly to the target AP MLD in which case the link used for exchanging the Link Reconfiguration Request/Response is in active mode while the other added link(s) is/are in power save mode. In some embodiments, the Link Reconfiguration Request and Link Reconfiguration Response may carry the Reconfiguration Multi-Link element without Link Info field, e.g., when link addition is not needed in the roaming execution stage. In some embodiments, the non-AP MLD that conducts the seamless roaming announces the way (one of sequential way and parallel way) for the seamless roaming.

In some embodiments, in Option 2, Link Reconfiguration Request and Link Reconfiguration Response are used in roaming preparation. In some embodiments, the new defined roaming request and response frame are used in a roaming execution stage. In some embodiments, the Reconfiguration Multi-Link element with Link Info field may be carried in roaming request and response frame(s), e.g., when a roaming preparation stage does not exist in the seamless roaming. In some embodiments, the non-AP MLD that conducts the seamless roaming announce the way (one of sequential way and parallel way) for the seamless roaming.

In some embodiments, a method of conducting seamless roaming by second devices (non-AP MLD) with multiple link(s) seamlessly roaming between two first devices belonging a SMD includes announcing, by the SMD through its first device, the SMD capabilities and selecting, by the second device, one of sequential way and parallel way to conduct the seamless roaming from a serving first device to a target first device. In some embodiments, the SMD capabilities include parallel way versus sequential way, data frame forwarding from serving AP MLD to target AP MLD, rekeying during roaming. In some embodiments, when SMD supports parallel way, the second device uses power save mode enabling/disabling to select whether it use parallel way or sequential way to conduct the seamless roaming. In some embodiments, when the roaming is done through the serving first device, the added link(s) at the target first device is in power save mode. In some embodiments, before negotiated time when the serving first device stop the DL frame transmission to the second device, the serving first device can send a Link Reconfiguration Request frame to delete all the links. In some embodiments, before negotiated time when the serving first device stop the DL frame transmission to the second device, the serving first device can send Link Reconfiguration Request frame to delete all the links.

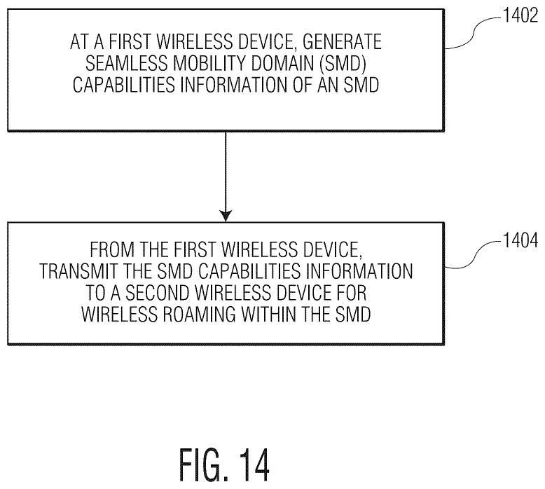

FIG. 14 is a process flow diagram of a method for wireless communications in accordance with an embodiment of the invention. At block 1402, at a first wireless device, Seamless Mobility Domain (SMD) capabilities information of an SMD is generated. At block 1404, from the first wireless device, the SMD capabilities information is transmitted to a second wireless device for wireless roaming within the SMD. In some embodiments, the first wireless device includes an access point (AP) MLD with at least one affiliated wireless AP, and the second wireless device includes a non-AP MLD with at least one affiliated non-AP station (STA). In some embodiments, the SMD capabilities information is transmitted to the non-AP MLD for the wireless roaming from a current serving AP multi-link device (MLD) to a target AP MLD within the SMD. In some embodiments, the SMD capabilities information includes an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming. In some embodiments, the information regarding the authentication and PTK generation supported by all the AP MLDs in the SMD is carried in a Robust Security Network Extension Element (RSNXE) element. In some embodiments, the information regarding the authentication and PTK generation supported by all the AP MLDs in the SMD is carried in a Robust Security Network Element (RSNE) element. In some embodiments, the SMD capabilities information includes information regarding a sequential way and a parallel way for the wireless roaming within the SMD. In some embodiments, based on the SMD capabilities information, the second wireless device selects the sequential way or the parallel way for the wireless roaming within the SMD. In some embodiments, a Reduced Neighbor Report (RNR) that contains information of a candidate target AP MLD, which carries a mobile domain identifier (MDID) of the SMD that the candidate target AP MLD belongs to, is generated. In some embodiments, the mobile domain identifier (MDID) of the SMD that the candidate target AP MLD belongs to includes a non-transmitted Basic Service Set Identifier (BSSID) index of an AP whose affiliated AP MLD is in the same SMD as the candidate target AP MLD. In some embodiments, a link reconfiguration request or response to terminate a downlink (DL) frame exchange with the second wireless device is generated. In some embodiments, the link reconfiguration request or response includes a reconfiguration multi-link element without a link information field. In some embodiments, the first wireless device is compatible with an Institute of Electrical and Electronics Engineers (IEEE) 802.11 protocol. In some embodiments, a Basic Service Set (BSS) Transition Management (BTM) Query carries an indication of soliciting candidate target AP MLDs through a BSS Transition Query Reason field. In some embodiments, the first wireless device includes a wireless multi-link device (MLD), the second wireless device includes a second wireless MLD, and the SMD capabilities information is transmitted to the second wireless MLD through a wireless link between the wireless MLD and the second wireless MLD. The first wireless device may be the same as or similar to an embodiment of the AP 106 depicted in FIG. 1, the APs 206-1, 206-2 depicted in FIG. 2, and/or the wireless device 300 depicted in FIG. 3. The second wireless device may be the same as or similar to an embodiment of the STA 110-1, . . . or 110-n depicted in FIG. 1, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate Seamless Mobility Domain (SMD) capabilities information of an SMD; and
a transceiver configured to transmit the SMD capabilities information to a second wireless device for wireless roaming within the SMD.

2. The wireless device of claim 1, wherein the wireless device comprises an access point (AP) MLD with at least one affiliated wireless AP, and wherein the second wireless device comprises a non-AP MLD with at least one affiliated non-AP station (STA).

3. The wireless device of claim 2, wherein the transceiver is further configured to transmit the SMD capabilities information to the non-AP MLD for the wireless roaming from a current serving AP multi-link device (MLD) to a target AP MLD within the SMD.

4. The wireless device of claim 1, wherein the SMD capabilities information comprises an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming.

5. The wireless device of claim 4, wherein the information regarding the authentication and PTK generation supported by all the AP MLDs in the SMD is carried in a Robust Security Network Extension Element (RSNXE) element.

6. The wireless device of claim 5, wherein the information regarding the authentication and PTK generation supported by all the AP MLDs in the SMD is carried in a Robust Security Network Element (RSNE) element.

7. The wireless device of claim 1, wherein the controller is further configured to generate a Reduced Neighbor Report (RNR) that contains information of a candidate target AP MLD, which carries a mobile domain identifier (MDID) of the SMD that the candidate target AP MLD belongs to.

8. The wireless device of claim 7, wherein the mobile domain identifier (MDID) of the SMD that the candidate target AP MLD belongs to comprises a non-transmitted Basic Service Set Identifier (BSSID) index of an AP whose affiliated AP MLD is in same SMD as the candidate target AP MLD.

9. The wireless device of claim 1, wherein the controller configured to generate a link reconfiguration request or response to terminate a downlink (DL) frame exchange with the second wireless device.

10. The wireless device of claim 9, wherein the link reconfiguration request or response comprises a reconfiguration multi-link element without a link information field.

11. The wireless device of claim 1, wherein a Basic Service Set (BSS) Transition Management (BTM) Query carries an indication of soliciting a plurality of candidate target AP MLDs through a BSS Transition Query Reason field.

12. The wireless device of claim 1, wherein the wireless device comprises a wireless multi-link device (MLD), wherein the second wireless device comprises a second wireless MLD, and wherein the transceiver comprises a wireless transceiver configured to transmit the SMD capabilities information to the second wireless MLD through a wireless link between the wireless MLD and the second wireless MLD.

13. A method for wireless communications, the method comprising:
at a first wireless device, generating Seamless Mobility Domain (SMD) capabilities information of an SMD; and
from the first wireless device, transmitting the SMD capabilities information to a second wireless device for wireless roaming within the SMD.

14. The method of claim 13, wherein the wireless device comprises an access point (AP) MLD with at least one affiliated wireless AP, and wherein the second wireless device comprises a non-AP MLD with at least one affiliated non-AP station (STA).

15. The method of claim 14, wherein transmitting the SMD capabilities information to the second wireless device for wireless roaming within the SMD comprises transmitting the SMD capabilities information to the non-AP MLD for the wireless roaming from a current serving AP multi-link device (MLD) to a target AP MLD within the SMD.

16. The method of claim 13, wherein the SMD capabilities information comprises an SMD Media Access Control (MAC) address, information regarding authentication and Pairwise Transient Key (PTK) generation supported by all AP MLDs in the SMD, and information regarding whether or not the SMD requires a Temporal Key (TK) renegotiation during the wireless roaming.

17. The method of claim 16, wherein the information regarding the authentication and PTK generation supported by all the AP MLDs in the SMD is carried in a Robust Security Network Extension Element (RSNXE) element.

18. The method of claim 17, wherein information regarding the authentication and PTK generation supported by all the AP MLDs in the SMD is carried in a Robust Security Network Element (RSNE) element.

19. The method of claim 13, further comprising at the first wireless device, generating a Reduced Neighbor Report (RNR) that contains information of a candidate target AP MLD, which carries a mobile domain identifier (MDID) of the SMD that the candidate target AP MLD belongs to.

20. The method of claim 19, wherein the mobile domain identifier (MDID) of the SMD that the candidate target AP MLD belongs to comprises a non-transmitted Basic Service Set Identifier (BSSID) index of an AP whose affiliated AP MLD is in same SMD as the candidate target AP MLD.
